(19) United States
(12) Patent Application Publication
(10) Pub. No.: US 2006/0039602 A1
(43) Pub. Date: Feb. 23, 2006

(54) Data driven color conversion

(76) Inventor: Svetlana M. Isakharov, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/923,173

(22) Filed: Aug. 20, 2004

(51) Int. Cl. G06K 9/00; G06F 17/14

(52) U.S. Cl. 382/162; 708/401

(57) ABSTRACT

A system for data driven color conversion is disclosed. The system may include a plurality of interconnected processors. At least one of the processors may include a first processing unit to perform a first portion of a color conversion scheme to generate first intermediate pixel data from pixel data, and a second processing unit to perform a second portion of the color conversion scheme using the first intermediate pixel data.

### RELATED APPLICATIONS

This patent application is related to U.S. patent application Ser. No. 10/600,047, titled “Hierarchical Processor to Processor Communication Method for a Data Driven Component Architecture,” filed Jun. 19, 2003, by Louis Lippincott, and assigned to the assignee of the present invention.

### BACKGROUND

A color image's pixel data may be expressed in a variety of color formats. A couple of the more common color formats are red-green-blue (RGB) and cyan-magenta-yellow-black (CMYK). Often, one device, such as a digital camera, may generate color images in the RGB format while another device, such as a printer may print color images in the CMYK format. Consequently, it may be necessary to convert the color format of a digital image's pixel data from the RGB format to the CMYK format before that image can be printed.

Color format conversion processing of image data may be undertaken using dedicated logic, such as an application-specific integrated circuit (ASIC), specifically designed to perform the calculations needed to convert the image's pixel data from one color format to another color format. ASICs, however, may be expensive to implement and tend to lack flexibility. Alternatively, color format conversion processing may be undertaken using a general purpose processor. The typical general purpose processor, however, may not be suitable for efficient and rapid color format conversion, particularly of high-resolution images.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system;

FIG. 2 illustrates some components of the system of FIG. 1 in more detail;

FIG. 3 illustrates some components of system of FIGS. 1 and 2 in more detail;

FIG. 4 is a flow chart illustrating a process of color format conversion of multiple color pixels;

FIG. 5 is a flow chart illustrating an example color conversion process; and

FIGS. 6A,B are flow charts illustrating another example color conversion process.

### DETAILED DESCRIPTION

The following detailed description refers to the accompanying drawings. The same reference numbers may be used in different drawings to identify the same or similar elements. For the purposes of explanation rather than limitation the following description sets forth specific details such as particular structures, architectures, interfaces, techniques, etc. in order to provide a thorough understanding of the various aspects of the claimed invention. However, it will be apparent, in light of the present disclosure, that the various aspects of the invention claimed may be practiced in other examples that depart from these specific details. In certain instances, descriptions of well known devices, circuits, and methods are omitted so as not to obscure the description of the present invention with unnecessary detail.

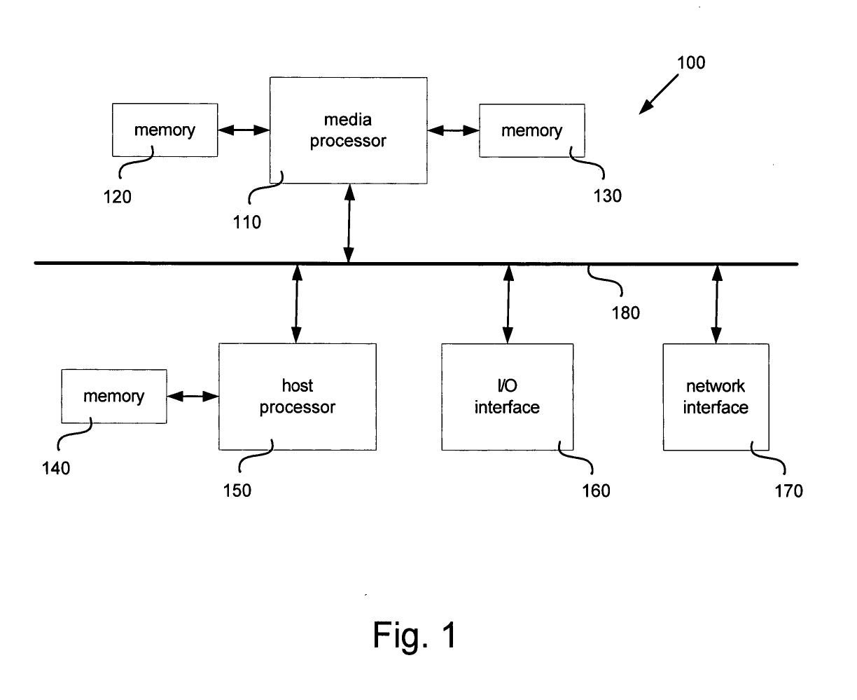

FIG. 1 illustrates an example system 100. Example implementations of system 100 may include color printers, color copiers and/or color document scanners, although the claimed invention is not limited in this regard. For example, system 100 may be embodied within a general-purpose computer, a portable device, a consumer electronics device, such as digital camera, and/or another electrical system. Although system 100 may be embodied in a single device, in some implementations certain components of system 100 may be remote and/or physically separated from other components of system 100. Further, although system 100 is illustrated as including discrete components, these components may be implemented in hardware, software/firmware, and/or any combination thereof. When implemented in hardware, some components of system 100 may be combined in a certain chip or device and/or implemented in multiple chips that may be packaged together.

System 100 may include a media processor 110, memories 120-140, a host processor 150, an I/O interface 160, a network interface 170, and a bus 180. Data, such as color image data to be processed by system 100 may enter system 100 through any number of devices linked to I/O interface 160 and/or network interface 170. Such data may be sent to any of memories 120-140 for processing by one or more components of system 100. For example, data sent to memory 120 may be processed by media processor 130, although the invention is not limited in this regard. Processed data may be returned to memory 120 and/or may be sent to memory 140, and the data in memory 140 may be sent to memory 140 and/or may be sent to I/O interface 160 and/or network interface 170 for delivery to devices external to system 100. For the purposes of explanation, the data sent and operated upon may include color pixel data (e.g., data specifying pixels of a digital color image), but the claimed invention is not limited in this regard. Media processor 130 may process other types of data than color information consistent with the description herein.

Color data processed by system 100 may include color information encoded in a specific format or space such as red-green-blue (RGB), cyan-magenta-yellow-black (CMYK), Commission Internationale de l'Eclairage Luminance-a-b (CIELab), and/or CIEXYZ. The claimed invention is not limited to the color spaces specifically mentioned herein; rather any now-known or later-developed color space or format may be used in accordance with the schemes disclosed herein.

In some implementations, color pixel data processed by system 100 may be provided by a reader (not shown) to read the media information from a storage medium communicatively coupled to I/O interface 160. For example, such a reader may include an optical, magnetic, and/or electrical reader to extract the color pixel information from a DVD, hard disk, semiconductor storage device, or other storage medium communicatively coupled to I/O interface 160.

In some implementations, color pixel data to be processed by system 100 may be provided by network interface 170. Network interface 170 may be arranged to receive information from a wired, optical, and/or wireless transmission medium and may, or may not, include receiver circuitry arranged to operate in conjunction with a tuner (not shown) or other device to separate desired information from other received information. Network interface 170 may be arranged to interface to communications networks such as a local area network (LAN) and/or a wide area network (WAN) although the invention is not limited in this regard. In some implementations, color pixel data may be provided directly to media processor 110 through a separate communications link (not shown).

Memory 120 may receive and store the color pixel information. If instructed by media processor 110, memory 130 may provide converted and/or processed color pixel data to host processor 150 and/or host processor 150 may read such processed color pixel data when triggered by media processor 110. Memories 120 and 130 may include random access memory (RAM) to facilitate rapid transfer and storage of data, although the invention is not limited in this regard. Such RAM may be synchronous, asynchronous, double data rate (DDR), etc. according to the design parameters of system 100.

In addition to storing color data, memory 120 and/or memory 130 may store instructions for use by media processor 110 and/or its components. Such instructions may be task-specific, and may be provided to media processor 110 when requested. Further, memory 120 and/or memory 130 may include one or more sets of such instructions that, when loaded by media processor 110, enable media processor 110 to perform a variety of processing tasks on the color pixel data (e.g., converting the color format of image pixel data).

In some implementations, host processor 150 may provide instructions to media processor 110 and/or memories 120-130. In addition, host processor 150 may obtain such instructions from sources external to system 100 through I/O interface 160 and/or network interface 170. In some implementations, host processor 150 may provide color pixel data to media processor 110 and/or memories 120-130. In addition, host processor 150 may obtain color pixel data from sources external to system 100 and/or may provide converted and/or processed color pixel data to such external sources using I/O interface 160 and/or network interface 170. In some implementations, host processor 150 may initialize and/or configure media processor 110 and/or its components although the invention is not limited in this regard.

Bus 180 may communicatively couple components of system 100. For example, bus 180 may convey instructions and/or color pixel data from host processor 150 to media processor 110 and/or to memories 120-130. In addition, bus 180 may, for example, convey color pixel data from I/O interface 160 and/or network interface 170 to media processor 110 and/or to memories 120-130. In some implementations, bus 180 may comprise a peripheral component interconnect (PCI) bus, although the invention is not limited in this regard.

I/O interface 160 may be arranged to interface to one or more devices and/or data sources external to system 100 such as a digital camera, a digital video recorder and/or any number of other such devices capable of generating and/or providing color pixel data. In addition, I/O interface 160 may be coupled to such devices and/or data sources using one or more communications ports compatible with communications standards such as universal serial bus (USB) and/or Institute of Electrical and Electronics Engineers (IEEE) 1394, to name several examples.

Although elements 120 and 130 have been described as physically separate memories, the claimed invention is not limited in this regard, but instead encompasses any device or interface capable of storing the color pixel data to be processed by media processor 110 and/or the color data processed by media processor 110. For example, memories 120 and 130 need not necessarily be separate or distinct in some implementations.

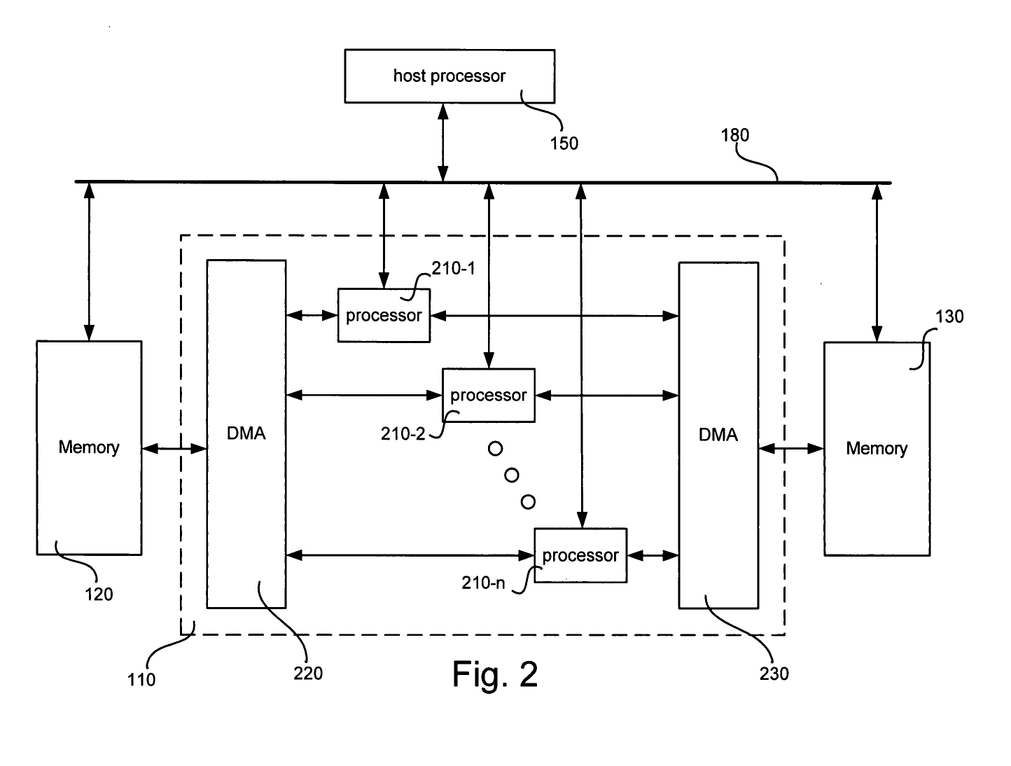

FIG. 2 illustrates some components of system 100 in more detail including internal components of media processor 110. Media processor 110 may include a number of low-level processors 210-1, 210-2, . . . , 210-n (collectively “processors 210”), and two direct memory access (DMA) engines 220 and 230. In some implementations, all of elements 210-230 may be located in the same chip and/or chip package. In some implementations, however, processors 210, DMAs 220 and 230, as well as memories 120 and 130 may be in one chip and/or chip package. Other combinations and implementations are possible.

In some implementations, some processing operations may be “data-driven.” For example, media processor 110 may examine indicator data to determine what type of processing should be performed. In some implementations the indicator data may be included and/or added to the color pixel data to be processed although the invention is not limited in this regard. Media processor 110 may then configure low-level processors 210 with appropriate instructions from, for example, memory 120 to process the color pixel data associated with the indicator data. Media processor 110 may also assign certain ones of low-level processors 210 to process certain data and/or perform certain tasks in parallel. In addition, media processor 110 may reconfigure low-level processors 210, as needed, based on newly received indicator data. Moreover, as will be discussed in more detail below, indicator data may also be used to designate that associated pixel data should be processed by certain processing elements internal to low-level processors 210.

Although not explicitly illustrated in FIG. 2 for simplicity of explanation, low-level processors 210 may be interconnected in some implementations, for example, in a matrix-type arrangement where one of low-level processors 210 may be connected to one, two, three, or more others of low-level processors 210, although the invention is not limited in this regard. In some implementations, there may a single digit number of low-level processors 210 (e.g., four or eight), but in other implementations there may be a double-digit number of low-level processors 210 (e.g., 16, 20, 32, 40, etc.). Also, though low-level processors 210 will be described as executing a processing task, in some implementations each of low-level processors 210 may execute a sub-task in conjunction with one or more of low-level processors 210. Other architectural and processing flow variations are both possible and contemplated for low-level processors 210.

In any event, low-level processors 210 may receive instructions from memory 120 and pixel data to process using those instructions based on direction from media processor 110. Depending on the instructions received, each of low-level processors 210 may be arranged to be a specific-purpose processor, with different processing tasks possible among the processors. In some implementations, low-level processors 210 may be arranged to retrieve and process their respective data, possibly in parallel. Because of the configuration of low-level processors 210 by media processor 110 and their ability to implement parallel processing both across multiple low-level processors 210 and within individual low-level processors 210, media processor 110 may be referred to as having a parallel, data-driven architecture.

DMA 220 may read and/or write pixel data from and/or to memory 120. In so doing, DMA 220 may facilitate media processor 110 in reading indicator data associated with color pixel data to be processed. DMA 220 may also provide instruction data and color pixel data to be processed to low-level processors 210. DMA 220 also may control data flow among low-level processors 210. Although DMA 220 is illustrated as connected to memory 120 with a single connection, it should be understood that such merely shows bi-directional data transfer between DMA 220 and memory 120, and does not limit the claimed invention. In practice, one or more additional (e.g., control) connections may exist between DMA 220 and memory 120, even though not explicitly shown in FIG. 2. This illustrative principle also applies to other connections shown in both FIGS. 1 and 2.

DMA 230 may read and/or write data from and/or to memory 130 and, in so doing, may, for example, facilitate media processor 110 in reading color pixel data processed by low-level processors 210 and stored in memory 130. In other implementations, DMA 230 may also provide instruction data and data to be processed to low-level processors 210 and/or may control data flow among low-level processors 210. In one implementation, DMA 230 may provide color pixel data processed by media processor 110 to be stored in memory 130.

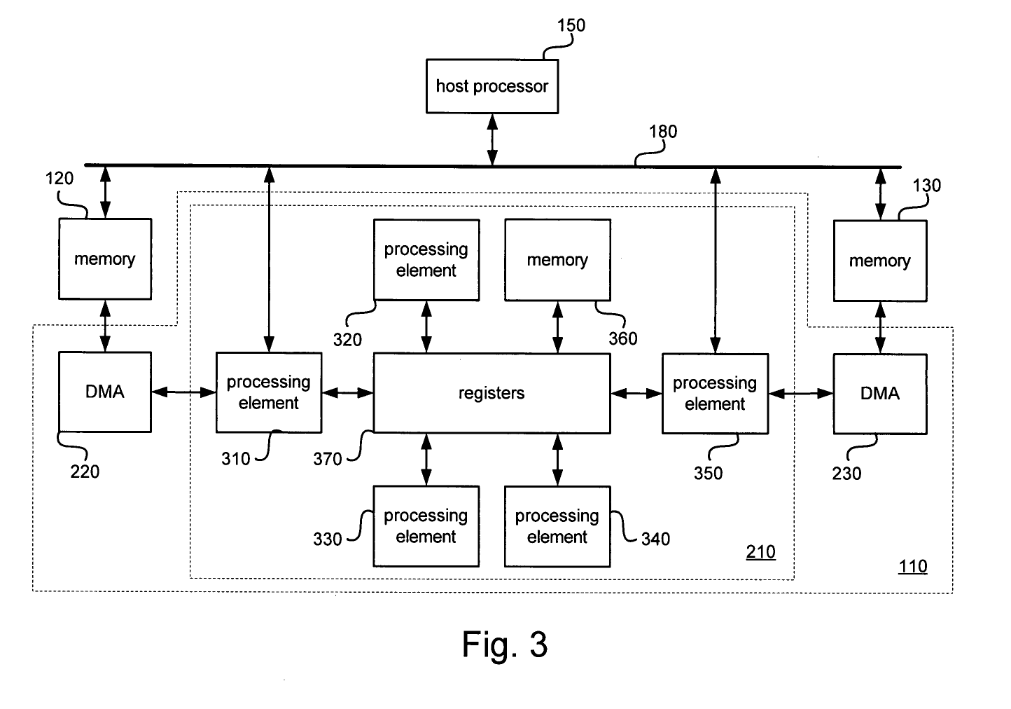

FIG. 3 illustrates some of the elements of system 100 including the internal components of one of the low-level processors 210 of media processor 110 in more detail. Low-level processor 210 may include a number of processing units and/or elements, in this example five processing elements 310-350, each with smaller amounts of instruction memory (not shown) than media processor 110. Low-level processor 120 may also include a data memory 360, and registers 370. In some implementations, data memory 360 may store data used by processing elements 310-350 in performing processing tasks. In one implementation, data memory 360 may have about 8 kilobytes (KB) of RAM, although the claimed invention is not limited in this regard.

Registers 370 may serve to communicatively couple processing elements 310-350, enabling the flow of pixel data and/or instructions between processing elements 310-350. In one implementation, registers 370 may enable the communication of 16-bit pixel data segments between processing elements 310-350 and may comprise sixteen 16-bit wide registers, one register holding a single 16-bit pixel data segment. In addition, registers 370 may enable the communication of indicator data between processing elements 310-350. For example, in one implementation, registers 370 may enable the communication of 8-bit indicator data and/or instructions associated with one or more 16-bit pixel data segments, the indicator data informing processing elements 310-350 of which of processing elements 310-350 should receive the associated data segments.

Processing elements 310-350 may provide and/or generate indicator data. For example, processing element 310 may provide indicator data along with associated color pixel data, such as RGB pixel data comprising three 8-bit color components, to registers 370, the indicator data indicating the associated RGB data should be processed by processing element 330. Although each of processing elements 310-350 are illustrated as being connected to registers 370 with a single connection, it should be understood that such merely shows bi-directional data transfer between elements 310-350 and registers 370, and does not limit the claimed invention. In practice, one or more additional (e.g., control) connections may exist between each of processing elements 310-350 and registers 370, even though not explicitly shown in FIG. 3. This illustrative principle also applies to other connections shown FIG. 3.

Processing elements 310-350 may provide some common functionality but need not be identical in function and/or structure. For example, one or more of elements 310-350, such as elements 310 and 350 may provide input and/or output functionality to enable the flow of data into or out of low-level processor 210, although the claimed invention is not limited in this regard. Others of processing elements 310-350 may, for example, provide more specialized functionality such as multiply and accumulate functionality, although, one again, the claimed invention is not limited in this regard.

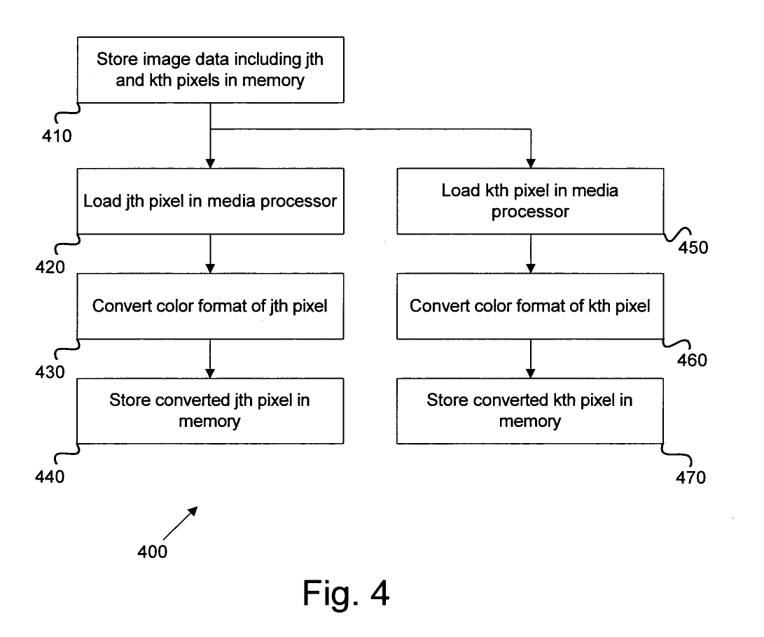

FIG. 4 is a flow chart illustrating a scheme and/or process 400 of color format conversion of data representing multiple color pixels. Although process 400 may be described with regard to system 100 and FIGS. 1-3 for ease of explanation, the claimed invention is not limited in this regard. In one implementation, process 400 may provide color format conversion for multiple color image pixels in a substantially parallel manner. For example, process 400 may engage one or more of processing elements 310-350 to convert the color format of even-numbered color pixels while, at substantially the same time, may engage another one or others of processing elements 310-350 to convert the color format of odd-numbered color pixels, although the invention is not limited in this regard. Moreover, such substantially parallel color conversion processing is not limited to parallel conversion using processing elements 310-350 of only one of low-level processors 210, rather, in other implementations, process 400 may engage processing elements 310-350 of two or more of low-level processors 210 to provide substantially parallel color conversion processing.

In another implementation, process 400 may provide color format conversion for multiple color image pixels in a substantially pipelined manner. For example, process 400 may engage one or more of processing elements 310-350 of a single low-level processor 210 to convert the color format of pixels in a sequential manner as will be described in more detail below. Clearly, the parallel, data-driven architecture of media processor 110 permits many permutations and/or combinations of low-level processors 210 and respective processing elements 310-350 to effect various combinations of both parallel and/or pipelined color conversion processes, and thus the invention is not limited in this regard.

Processing may begin with the storage of color image pixel data in memory [act 410]. In one embodiment, host processor 150 may store a segment and/or swath of color image pixels in memory 120. The pixels stored in act 410 may be in a first color format, such as RGB, although the invention is not limited to specific color formats. Processing may continue with the provision of pixel data (e.g., the jth pixel) for color conversion processing [act 420]. In one implementation, a low-level processor 210 of media processor 110 may use DMA 220 to fetch a pixel's data from the color image data stored in memory 120. The color format of that pixel data may then be converted [act 430] and the resulting converted pixel data may be stored in memory [act 440]. In one implementation, low-level processor 120 uses one or more of processing elements 310-350 to convert the color format of the jth pixel and stores the converted pixel data in memory 130 using DMA 230.

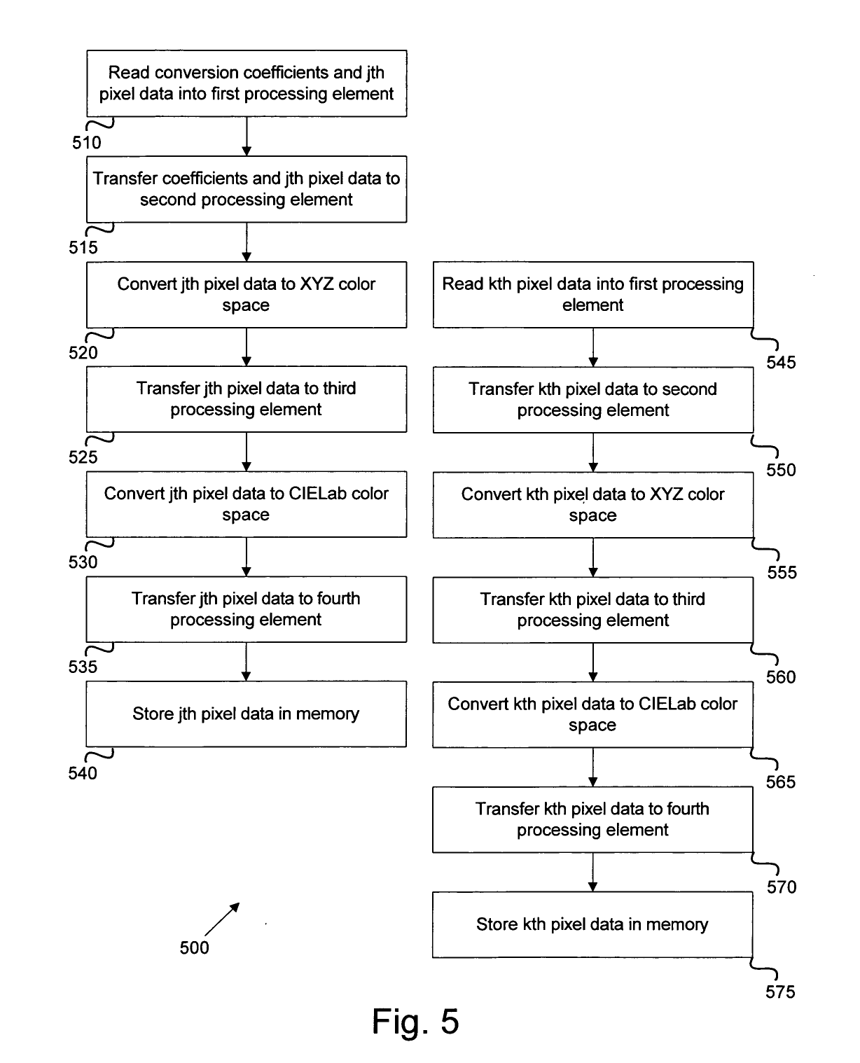

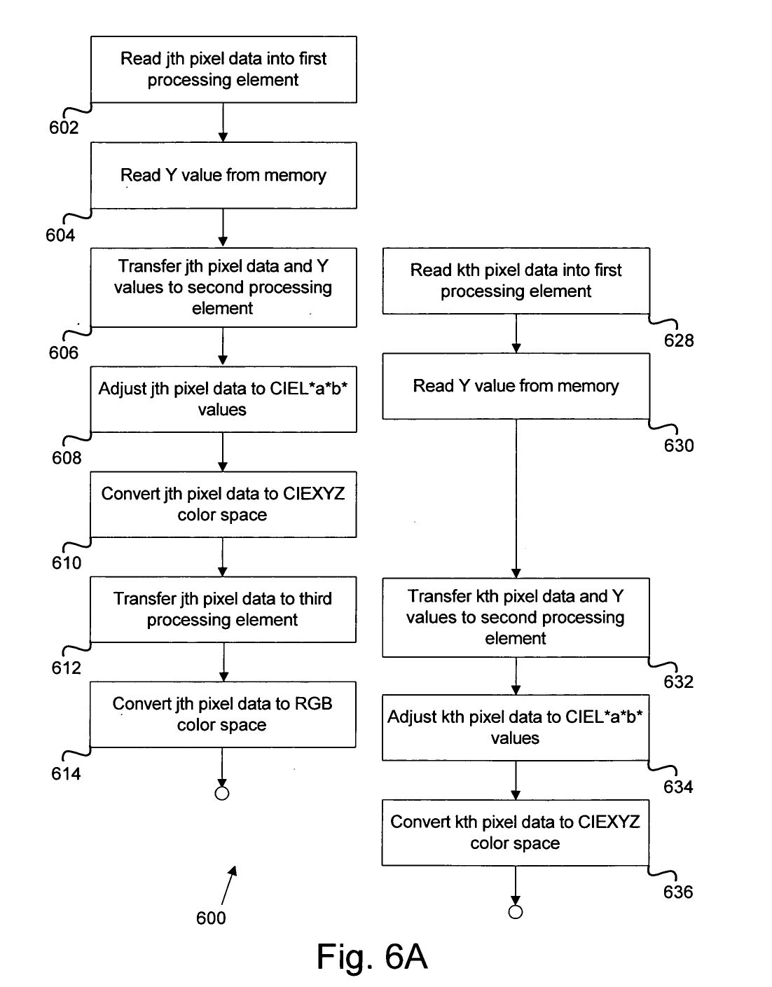

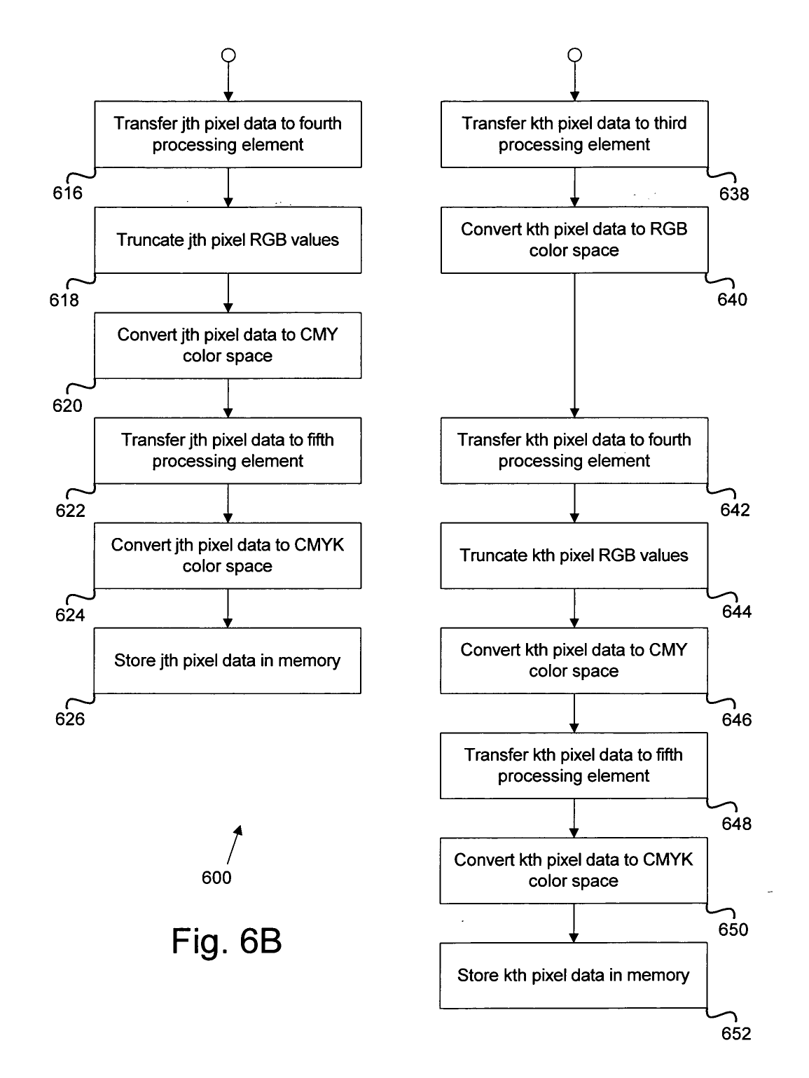

As described above, process 400 implements the color format conversion of multiple pixels. Thus, in addition to the processing of the jth pixel in acts 420-440, process 400 may also include processing of at least an additional pixel's data. A second pixel's data (e.g., the kth pixel) may be provided [act 450] for color format conversion processing [act 460] and the resulted converted pixel data stored in memory [act 470]. Color format conversion of acts 430 and 460 may comprise several sub-acts the exact number and nature of which will depend upon the origin and destination color formats. Specific implementations of acts 430 and 460 will be discussed in greater detail below with reference to FIGS. 5 and 6a,b and respective processes 500 and 600.

As discussed generally above, in one implementation, acts 420-440 may be performed at substantially the same time and thus in a substantially parallel manner as acts 450-470, although the invention is not limited in this regard. For example, one or more of processing elements 310-350 of a single low-level processor 210 may perform acts 420-440 providing for the color format conversion of the jth pixel while, at substantially the same time, another or others of processing elements 310-350 of the same low-level processor 210 may perform acts 450-470 providing for the color format conversion of the kth pixel. In another implementation, one or more of processing elements 310-350 of two or more low-level processors 210 may perform acts 420-440 providing for the color format conversion of the jth pixel while, at substantially the same time, another or others of processing elements 310-350 of two or more low-level processor 210 may perform acts 450-470 providing for the color format conversion of the kth pixel. Clearly other permutations and/or combinations may be possible consistent with the claimed invention.

Moreover, also discussed generally above, a single low-level processor 210 may perform both acts 420-440 and acts 450-470 in a substantially pipelined manner by utilizing one or more processing elements 310-350 of one low-level processor 210 and interleaving and/or staggering the execution of acts 420-470 as will be described in greater detail below with reference to FIGS. 5 and 6a,b and respective processes 500 and 600.

Although process 400 describes the substantially parallel and/or pipelined color conversion of two pixels the invention is not limited in this regard and also contemplates the substantially parallel and/or pipelined processing of three or more color pixels. For example, in one implementation a single one of low-level processors 210 may process pixels stored in memory 120 by interleaving and/or staggering the color conversion processing of those pixels using processing elements 310-350 as will be described in more detail below with respect to two representative pixels.

Two specific examples to aid in understanding system 100 and process 400 will now be presented. Although system 100 and process 400 may be amenable to converting color data between color formats or spaces, as described below, the claimed invention should not be limited thereto. Further, system 100 and process 400 may be amenable to much more complicated algorithms, whether color conversion or other types, than are discussed below.

FIG. 5 illustrates an example color conversion scheme and/or process 500 for the conversion of color pixel data for multiple color image pixels from the RGB space to the CIELab space through an intermediate and/or partially converted CIE x-y-z (CIEXYZ) color space. Although process 500 may be described with regard to system 100 and FIGS. 1-3 for ease of explanation, and may represent a specific example of the general process 400, the claimed invention is not limited in this regard. The specific source color space (i.e., RGB) and destination color space (i.e., CIEXYZ) information may be one example of indicator data, because it indicates to media processor 110 and/or one of low-level processors 210 what processing tasks should be performed on the color pixel data.

Process 500 may operate on individual pixels of color data, such as 24-bit data RGB pixel values, although the invention is not limited in this regard and other RGB data formats, such as 8-bit RGB, 18-bit RGB and/or system-specific RGB formats and/or color spaces such as sRGB may be processed. Another example of indicator data may be which of low-level processors 210 should process a particular segment of color pixel data. Furthermore, one or more of processing elements 310-350 of a low-level processor 210 may modify and/or reconfigure indicator data associated with color pixel data. In other words, processing element 310 may, for example, modify indicator data associated with a pixel that processing element 310 has processed to indicate that processing element 320, for example, should undertake further processing of that pixel data.

Although process 500 may, as described below, utilize particular ones of processing elements 310-350 of a low-level processor 210 within media processor 110, and may utilize individual ones of processing elements 310-350 in a particular order, the invention is not limited in this regard and other combinations and/or sequences of utilizing processing elements 310-350 are contemplated by the invention. Further, although specific portions and/or acts of process 500 may be described as being performed by particular ones of processing elements 310-350, the invention is not limited in this regard and acts and/or portions of acts of process 500 may be performed by and/or distributed across different ones and/or combinations of processing elements 310-350 and remain within the scope and spirit of the invention.

Conversion of RGB color pixel data to CELab color pixel data may comprise a linear transformation from RGB color values to CIEXYZ color values followed by a non-linear transformation from CIEXYZ color values to CIELab color values according to well known formulas. A linear transformation from RGB color values to CIEXYZ color values may utilize a set of well known conversion coefficients according to the formula:

$$[ \begin{matrix}X \\ Y \\ Z\end{matrix} ] = [ \begin{matrix}0.4361 & 0.3851 & 0.1431 \\ 0.2225 & 0.7169 & 0.0606 \\ 0.0139 & 0.0971 & 0.7141\end{matrix} ] \times [ \begin{matrix}R \\ G \\ B\end{matrix} ] \qquad ( 1 )$$

followed by a non-linear transformation of the resulting CIEXYZ values to CIELab values according to the well known formulas:
L=116 f(Y/Yn)−16;
a=500 [f(X/Xn)−f(Y/Yn)];
b=200 [f(Y/Yn)−f(Z/Zn)], (2)
where Xn=245.9, Yn=255 and Zn=210.4 denotes the XYZ values for the reference CIE white color; and f(r)=r^{1/3} if r>0.008856 otherwise f(r)=(7.7867r+16/116).

Instructions forming algorithms for implementing operations in accord with equations (1) and (2), such as sets of instructions in the form of micro-code programs, may be stored in instruction memory (not shown) associated with processing elements 310-350, although the invention is not limited in this regard. In one implementation, host processor 150 may store instructions for implementing operations in accord with equations (1) and (2) in memory, such as memory 120, and media processor 110 may retrieve those instructions for storage in instruction memory associated with one or more processing elements 310-350 of one or more low-level processors 210.

Process 500 may begin with the reading of RGB color data corresponding to one pixel (e.g., the jth pixel) and RGB to XYZ format conversion coefficients into a first processing element [act 510]. The conversion coefficients may be, for example, the coefficients of equation (1) shown above. In one implementation, processing element 310 may read data corresponding to one RGB pixel from memory 120 using DMA 220. Although the data read in during act 502 may be described as RGB color data, the order in which RGB color components are loaded into and/or read out of memory 120 may be different, for example, the color pixel data may be loaded into and/or read out of memory 120 in an interleaved BGR order, although the invention is not limited in this regard. In addition, processing element 310 may simultaneously read in the RGB pixel data and the conversion coefficients from memory 120 using two data paths and/or data ports, one for the RGB pixel data and one for the conversion coefficients, although the invention is not limited in this regard. Moreover, the pixel data stored in memory 120 and read into processing element 310 may be in a packed 16-bit format in which case processing element 310 may unpack the pixel data, although the invention is not limited in this regard.

Processing may continue with the transfer of the first RGB pixel data and conversion coefficients to a second processing element [act 515]. In one implementation this may be accomplished by processing element 310 placing the jth pixel RGB data and conversion coefficients in registers 370 along with indicator data indicating that the jth pixel RGB data is intended for processing by processing element 330. In response to the indicator data, processing element 330 may load the first RGB pixel data and conversion coefficients from registers 370 to complete the transfer of act 515.

Processing may continue with conversion of the jth pixel color data from the RGB color space to the XYZ color space [act 520]. In one implementation, processing element 330 converts the jth pixel RGB data retrieved from registers 370 using the conversion coefficients of equation (1), also retrieved from registers 370. Following conversion from RGB color format to XYZ color format, the jth pixel color data may be transferred to a third processing element [act 525]. In one implementation, processing element 330 may place the jth pixel data in the XYZ format as produced in act 520 in registers 370 along with indicator data indicating that the jth pixel data is intended for processing by processing element 340. In response to the indicator data, processing element 340 may load the jth pixel data from registers 370 to complete the transfer of act 525.

Processing may continue with conversion of the jth pixel color data from the XYZ color space to the CIELab color space [act 530]. In one implementation, processing element 340 may convert the jth pixel XYZ data retrieved from registers 370 using the operations shown above in equation (2). With reference to equation (2), values corresponding to r^{1/3}, where r=(Y/Yn), r=(X/Xn) and r=(Z/Zn) for all possible combinations X, Y and Z values, may be stored in memory 360 in the form of an XYZ conversion look-up table (LUT). Processing element 340 may access the XYZ conversion LUT stored in memory 360 via registers 370 when converting the jth pixel color data from the XYZ color space to the CIELab color space in act 530. In one implementation, the XYZ conversion LUT may be generated by host processor 150 and placed in memory 360 prior to the implementation of act 530.

Processing may continue with the transfer of the jth pixel color data to a fourth processing element [act 535]. In one implementation, processing element 340 may place the jth pixel color data in CIELab format as produced in act 530 in registers 370 along with indicator data indicating that the jth pixel data is intended for processing by processing element 350. In response to the indicator data, processing element 350 may load the jth pixel data from registers 370 to complete the transfer of act 535. Processing may continue with the storing of the processed jth pixel data in the CIELab color format in memory [act 540]. To accomplish act 540, processing element 350 may store the jth pixel data in CIELab color format, retrieved from registers 370, in memory 130 using DMA 230. In one implementation, processing element 350 may pack the jth pixel data into a 16-bit format before storing the data in memory 130, although the invention is not limited in this regard.

As discussed above with regard to general process 400, process 500 may include the substantially pipelined processing of multiple pixels. In other words, in addition to the color conversion of one pixel (e.g., the jth pixel), process 500 may also comprise the color conversion of at least one additional pixel (e.g., the kth pixel) using the same processing elements as acts 510-540. Thus, in one implementation, as will be discussed in greater detail below, process 500 may be undertaken using one of low-level processors 210 and color conversion processing of a kth pixel [acts 545-575] may be performed following a substantially similar sequence of events and using substantially similar processing elements as acts 510-540 except that the events of acts 545-575 are delayed and/or staggered and/or interleaved with respect to the events of acts 510-540.

Process 500 may provide for the color conversion of the kth pixel by the reading of RGB color data corresponding to the kth pixel into a first processing element [act 545] in a manner substantially similar to the reading of the jth pixel in act 510 as described above. Because process 500 describes a substantially pipelined process, act 545 may proceed substantially contemporaneously with or after act 515 (i.e., the transfer of the jth pixel data and the conversion coefficients to the second processing element).

Processing of the kth pixel may continue with the transfer of the kth pixel data to the second processing element [act 550] in a manner substantially similar to the transfer of the jth pixel data in act 515 as described above. In one implementation, act 550 may proceed substantially contemporaneously with or after act 525 (i.e., the transfer of the jth pixel data to the third processing element).

Processing of the kth pixel may continue with conversion of the kth pixel color data from the RGB color space to the XYZ color space [act 555] in a manner substantially similar to the conversion of the jth pixel data in act 520 as described above. Following conversion from RGB color format to XYZ color format, the kth pixel color data may be transferred to a third processing element [act 560] in a manner substantially similar to the conversion of the jth pixel data in act 525 as described above. In one implementation, act 560 may proceed substantially contemporaneously with or after act 535 (i.e., the transfer of the jth pixel data to the fourth processing element).

Processing may continue with conversion of the kth pixel color data from the XYZ color space to the CIELab color space [act 565] in a manner substantially similar to the conversion of the jth pixel data in act 530 as described above. Following conversion to the CIELab color space, processing may continue with the transfer of the kth pixel color data to a fourth processing element [act 570] in a manner substantially similar to the transfer of the jth pixel data in act 535 as described above. Processing may conclude with the storing of the processed kth pixel data in the CIELab color format in memory [act 575] in a manner substantially similar to the storage of the jth pixel data in act 540 as described above.

While process 500 may be described as a set of acts 510-575 performed by specific ones of processing elements 310-350, the invention is not limited in this respect and acts 510-575 may be performed by different ones of processing elements 310-350 and remain within the scope and spirit of the invention. For example, although the transfers described in acts 525 and 535 may be described as transfers, via registers 370, from processing element 330 to processing element 340 and from processing element 340 to processing element 350, respectively, other implementations of acts 525 and 535 are possible such as a transfer from processing element 330 to processing element 320 and a transfer from processing element 320 to processing element 350, respectively. Clearly, many similar permutations may be possible consistent with the claimed invention. Moreover, as discussed above with respect to general process 400, other color conversion processes wherein multiple pixels are processed in a substantially parallel manner are contemplated by the present invention.

FIGS. 6A and 6B illustrate an example color conversion scheme and/or process 600 for the conversion of color data for multiple color image pixels from the CIELab color space to the CMYK color space through intermediate and/or partially converted CIEXYZ and RGB color spaces. Although process 600 may be described with regard to system 100 and FIGS. 1-3 for ease of explanation, and may represent a specific example of the general process 400, the claimed invention is not limited in this regard. The specific source color space (i.e., CIELab) and destination color space (i.e., CMYK) information may be one example of indicator data, because it indicates what processing tasks should be performed on the color data.

Process 600 may operate on color image pixels comprising 24-bit CIELab values, although the invention is not limited in this regard and other CIELab data formats, such as 8-bit CIELab, and/or 18-bit CIELab may be processed. Another example of indicator data may be which of low-level processors 210 should process a particular pixel of color data. Furthermore, one or more of processing elements 310-350 of low-level processors 210 may modify and/or reconfigure indicator data associated with pixel color data. In other words, processing element 310 may, for example, reconfigure indicator data associated with a pixel's data that processing element 310 has processed to indicate that processing element 320, for example, should undertake further processing of that pixel's data.

Although process 600 may, as described below, utilize particular ones of processing elements 310-350 of a low-level processor 210 within media processor 110, and may utilize individual ones of processing elements 310-350 in a particular order, the invention is not limited in this regard and other combinations and/or sequences of utilizing processing elements 310-350 are contemplated by the invention. Further, although specific portions and/or acts of process 600 may be described as being performed by particular ones of processing elements 310-350, the invention is not limited in this regard and acts and/or portions of acts of process 600 may be performed by and/or distributed across different ones and/or combinations of processing elements 310-350 and remain within the scope and spirit of the invention.

Conversion of CIElab color data to CMYK color data may first comprise a non-linear transformation from CIELab color values to CIEXYZ color values according to well known formulas followed by a linear transformation from CIEXYZ color values to RGB color values according to other well known formulas. Subsequently, the RGB color values may be linearly transformed to CMYK according, again, to well known formulas. A non-linear transformation from CIELab color values to CIEXYZ color values may first comprise modifying, normalizing and/or adjusting the CIELab values from the range L,a,b [0, 255] to L* [0,100] and a*,b* [−100, 100].

The adjusted CIELab values (i.e., L*, a* and b*) may be used to calculate CIEXYZ values using the following formulas. For values of L*<8.0:

$$\frac{Y}{{Y}_{n}} = \frac{{L}^{*}}{903.3} \qquad ( 3 )$$

and for values of L*≧8.0:

$$\begin{matrix}\frac{Y}{{Y}_{n}} = {\frac{1}{100} [ \frac{{L}^{*} + 16}{25} ]}^{3} \\ where {Y}_{n} = 255. Given Y \text{:} & ( 4 ) \\ \frac{X}{{X}_{n}} = {[ \frac{{a}^{*}}{500} + {( \frac{Y}{{Y}_{n}} )}^{1 \text{/} 3} ]}^{3} & ( 5 ) \\ and \frac{Z}{{Z}_{n}} = {[ {( \frac{Y}{{Y}_{n}} )}^{1 \text{/} 3} - \frac{{b}^{*}}{200} ]}^{3} \\ where {X}_{n} = 245 and {Z}_{n} = 210. & ( 6 )\end{matrix}$$

Once the CIEXYZ values have been calculated from the modified CIELab values according to equations (3)-(6) above, the CIEXYZ values may be converted to RGB values using the following linear transformation:

$$[ \begin{matrix}R \\ G \\ B\end{matrix} ] = [ \begin{matrix}3.240479 & - 1.53715 & - 0.498535 \\ - 0.969256 & 1.875991 & 0.041556 \\ 0.055648 & - 0.20404 & 1.057311\end{matrix} ] \times [ \begin{matrix}X \\ Y \\ Z\end{matrix} ] \qquad ( 7 )$$

and the resulting RGB values may be converted to CMYK values according to the following linear transforms:

$$\begin{matrix}[ \begin{matrix}C \\ M \\ Y\end{matrix} ] = [ \begin{matrix}1 \\ 1 \\ 1\end{matrix} ] - [ \begin{matrix}R \\ G \\ B\end{matrix} ] \\ and & ( 8 ) \\ [ \begin{matrix}{C}_{k} \\ {M}_{k} \\ {Y}_{k}\end{matrix} ] = [ \begin{matrix}C \\ M \\ Y\end{matrix} ] - [ \begin{matrix}K \\ K \\ K\end{matrix} ] \\ where K = min ( C , M , Y ) . & ( 9 )\end{matrix}$$

Instructions forming algorithms for implementing operations in accord with equations (3) thru (9), such as sets of instructions in the form of micro-code programs, may be stored in instruction memory (not shown) associated with processing elements 310-350, although the invention is not limited in this regard. In one implementation, host processor 150 may store instructions for implementing operations in accord with equations (3) thru (9) in memory, such as memory 120, and media processor 110 may retrieve those instructions for storage in instruction memory associated with one or more processing elements 310-350 of one or more low-level processors 210.

Process 600 may begin with the reading of a pixel's data (e.g., the jth pixel) in CIELab color format into a first processing element [act 602]. In one implementation, processing element 310 may use DMA 220 to read the jth pixel color data from memory 120 where it was previously stored. In one implementation data corresponding to multiple pixels in the CIELab color format may be stored in memory 120 by host processor 150. In other implementations, media processor 110 may store and/or coordinate the storing of multiple pixels in the CIELab color format in memory 120. Although the data read into the first processing element in act 602 may be described as CIELab color data, the order in which CIELab data is read out from memory may be different, for example, the color data may be read into the first processing element in an interleaved chroma-luminance, baL order, although the invention is not limited in this regard. In one implementation, the pixel data stored in memory may be stored in a packed 16-bit format. In that case processing element 310 may unpack the jth pixel data after reading it from memory.

Processing may continue with the reading of a previously calculated Y value from memory [act 604]. In one implementation, host processor 150 may calculate Y values for all values of L* according to equations (3) and (4) above, and may load the resulting array of Y values in memory 360 for retrieval in act 604, although the invention is not limited in this respect. Once the Y values are stored in memory 360, processing element 310 may issue a read command and provide to memory 360, via registers 370, the read command indicating that memory 360 should supply a Y value to registers 370 along with indicator data indicating that the Y value is to be retrieved by another processing element as will be described below.

Processing may continue with the transfer of the jth pixel CIELab data to a second processing element [act 606]. In one implementation this may be accomplished by processing element 310 placing the jth pixel data in registers 370 along with indicator data indicating that the jth pixel data is intended for processing by processing element 330. In response to the indicator data, processing element 330 may load the jth pixel data from registers 370 to complete the transfer of act 606.

Processing may continue with the adjustment of the CIELab values to L*a*b* values [act 608] followed by the conversion of the L*a*b* pixel data to the XYZ color space [act 610]. In one implementation, processing element 330 may generate the L*a*b* values and use them to calculate the X/Xn and Z/Zn values using the Y value retrieved in act 604 and equations (5) and (6) above where Xₙ=245, Yₙ=255, and Zₙ=210. Processing may continue with the transfer of jth pixel data now in CIEXYZ format to a third processing element [act 612]. In one implementation this may be accomplished by processing element 330 placing the jth pixel data in registers 370 along with indicator data indicating that the data is intended for processing by processing element 340. In response to the indicator data, processing element 340 may load the CIEXYZ color data from registers 370 completing the transfer of act 612.

Process 600 may continue with the conversion of the jth pixel data from the CIEXYZ color space to the RGB color space [act 614]. On way to so this may be to have processing element 340 generate RGB values from the jth pixel CIEXYZ values provided in act 612 using the linear transform of equation (7) above. Processing may continue with the transfer of the jth pixel data to a fourth processing element [act 616]. In one implementation this may be accomplished by processing element 340 placing the jth pixel data in registers 370 along with indicator data targeting processing element 320. In response to the indicator data, processing element 320 may load the jth pixel RGB data from registers 370 to complete the transfer of act 616.

Processing may continue with the truncation of the jth pixel RGB values [act 618] and the conversion of the truncated jth pixel data from the RGB color space to the CMY color space [act 620]. In one implementation, processing element 320 may truncate the jth pixel RGB values by discarding all RGB values greater than 255 and less than zero. Processing element 320 may then calculate CMY values from the truncated RGB values using the linear transform of equation (8) above. Processing may continue with the transfer of the jth pixel CMY data to a fifth processing element [act 622]. In one implementation this may be accomplished by processing element 320 placing the jth pixel CMY data in registers 370 along with indicator data targeting processing element 350. In response to the indicator data, processing element 350 may load the jth pixel data from registers 370 completing the transfer of act 622.

Process 600 may continue with the conversion of the jth pixel data from the CMY color space to CMYK color space [act 624] and the storing of the resulting jth pixel CMYK data in memory [626]. This may be accomplished by having processing element 350 calculate the CMYK from the CMY values obtained in act 624 using the linear transform of equation (9) above. Processing element 350 may store the CMYK values in memory 130 using DMA 230. In one implementation, processing element 350 may pack the jth pixel CMYK values into 16-bit segments before storing them in memory 130 using DMA 230.

As discussed above with regard to process 500, process 600 may include the substantially pipelined processing of multiple pixels. In other words, in addition to the color conversion of one pixel (e.g., the jth pixel), process 600 may also comprise the color conversion of at least one additional pixel (e.g., the kth pixel) using the same processing elements of acts 602-626. Thus, in one implementation, as will be discussed in greater detail below, process 600 may be undertaken using one of low-level processors 210 and color conversion processing of a kth pixel [acts 628-652] may be performed following a substantially similar sequence of events and using substantially similar processing elements as acts 602-626 except that the events of acts 628-652 are delayed and/or staggered and/or interleaved with respect to the events of acts 602-626.

Process 600 may provide for the color conversion of the kth pixel by the reading of CIELab color data corresponding to the kth pixel into a first processing element [act 628] in a manner substantially similar to the reading of the jth pixel in act 602 as described above. Because process 600 describes a substantially pipelined process, act 628 may proceed substantially contemporaneously with and/or after act 606 (i.e., the transfer of the jth pixel data and the conversion coefficients to the second processing element).

Processing of the kth pixel may continue with the reading of a previously calculated Y value from memory [act 630] in a manner substantially similar to the reading of a Y value for the jth pixel in act 604 as described above. The kth pixel data may then be transferred to the second processing element [act 632] in a manner substantially similar to the transfer of the jth pixel data in act 606 as described above. In one implementation, act 632 may proceed substantially contemporaneously with and/or after act 612 (i.e., the transfer of the jth pixel data to the third processing element).

Processing of the kth pixel may continue with the adjustment of the CIELab values to L*a*b* values [act 634] followed by the conversion of the kth pixel L*a*b* data to the XYZ color space [act 636] in a manner substantially similar to respective acts 608 and 610 applied to the jth pixel as described above. Processing of the kth pixel may continue with the transfer of the kth pixel XYZ data to the third processing element [act 638] in a manner substantially similar to the transfer of jth pixel data in act 612 as described above. In one implementation, act 638 may proceed substantially contemporaneously with and/or after act 616 (i.e., the transfer of the jth pixel data to the fourth processing element).

Processing of the kth pixel may continue with the conversion of the kth pixel data to the RGB color space [act 640] in a manner substantially similar to the jth pixel conversion to RGB in act 614 as discussed above. The kth pixel data now in RGB color format may then be transferred to the fourth processing element [act 642] in a manner substantially similar to the transfer of the jth pixel conversion in act 616 as discussed above. In one implementation, act 642 may proceed substantially contemporaneously with and/or after act 622 (i.e., the transfer of the jth pixel data to the fifth processing element).

Processing may continue with the truncation of the jth pixel RGB data [act 644] and the subsequent conversion of the kth pixel data to the CMY color space [act 646] in a manner substantially similar to respective acts 618 and 620 applied to the jth pixel as described above. Process 600 may conclude with the transfer of the kth pixel CMY data to the fifth processing element [act 648], the conversion of the kth pixel data to the CMYK color space [act 650] and the storage of the processed kth pixel CMYK data in memory [act 652]. Acts 648-652 may be undertaken in a manner substantially similar to respective acts 622-626 applied to the jth pixel as described above.

While process 600 may be described as a set of acts 602-652 performed by specific ones of processing elements 310-350, the invention is not limited in this respect and acts 602-652 may be performed by different ones of processing elements 310-350 and remain within the scope and spirit of the invention. For example, although the transfers described in acts 606 and 638 may be described as transfers, via registers 370, from processing element 310 to processing element 330 and from processing element 330 to processing element 340, respectively, other implementations of acts 606 and 638 are possible such as a transfer from processing element 330 to processing element 320 and a transfer from processing element 320 to processing element 340, respectively. Clearly, many similar permutations may be possible consistent with the claimed invention. Moreover, as discussed above with respect to general process 400, other color conversion processes wherein multiple pixels are processed in a substantially parallel manner are contemplated by the present invention.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. The acts in FIGS. 5 and 6A,B need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium. Moreover, processes 500 and 600 may be combined to enable RGB to CMYK color format conversion processing.

No element, act, or instruction used in the description of the present application should be construed as critical or essential to the invention unless explicitly described as such. Also, as used herein, the article “a” is intended to include one or more items. Where only one item is intended, the term “one” or substantially similar language is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A system, comprising:
a plurality of interconnected processors, at least one of the processors including;
a first processing unit to perform a first portion of a color conversion scheme to generate first intermediate pixel data from pixel data, and
a second processing unit to perform a second portion of the color conversion scheme using the first intermediate pixel data.

2. The system of claim 1, the second processing unit to perform the second portion of the color format conversion scheme to generate converted pixel data from the first intermediate pixel data.

3. The system of claim 2, wherein the pixel data is in a red-green-blue (RGB) color format.

4. The system of claim 3, wherein the first intermediate pixel data is in a Commission Internationale de l'Eclairage x-y-z (CIEXYZ) format.

5. The system of claim 4, wherein the converted pixel data is in a Commission Internationale de l'Eclairage Luminance-a-b (CIELAB) color format.

6. The system of claim 1, the second processing unit to perform the second portion of the color format conversion scheme to generate second intermediate pixel data from the first intermediate pixel data.

7. The system of claim 6, further comprising:
a third processing unit to perform a third portion of the color format conversion scheme to generate third intermediate pixel data from the second intermediate pixel data.

8. The system of claim 7, further comprising:
a fourth processing unit arranged to perform a fourth portion of the color format conversion scheme to generate converted pixel data from the third intermediate pixel data.

9. The system of claim 8, wherein the pixel data is in a CIELAB color format.

10. The system of claim 9, wherein the first intermediate pixel data is in a CIEXYZ color format.

11. The system of claim 10, wherein the second intermediate pixel data is in a RGB color format.

12. The system of claim 11, wherein the converted pixel data is in a cyan-magenta-yellow-black (CMYK) color format.

13. The system of claim 1, further comprising:
at least one register coupling the first processing unit to the second processing unit.

14. The system of claim 13, the second processing unit to obtain at least the first intermediate pixel data from the at least one register.

15. A method, comprising:
providing pixel data to a first processing unit element;
partially converting the color format of the pixel data to generate first intermediate pixel data using the first processing element; and
transferring the first intermediate pixel data to a second processing element.

16. The method of claim 15, further comprising:
partially converting the color format of the first intermediate pixel data to generate converted pixel data using the second processing element.

17. The method of claim 16, wherein the pixel data is in a RGB color format.

18. The method of claim 17, wherein the first intermediate pixel data is in a CIEXYZ color format.

19. The method of claim 18, wherein the converted pixel data is in a CIELAB color format.

20. The method of claim 16, further comprising:
transferring the second intermediate pixel data to a third processing element.

21. The method of claim 20, further comprising:
partially converting the color format of the second intermediate pixel data to generate converted pixel data using the third processing element.

22. The method of claim 21, wherein the pixel data is in a CIELAB color format.

23. The method of claim 22, wherein the first intermediate pixel data is in a CIEXYZ color format.

24. The method of claim 23, wherein second intermediate pixel data is in a RGB color format.

25. The method of claim 24, wherein the converted pixel data is in a CMYK color format.

26. A method, comprising:
providing pixel data to a processing element;
partially converting the color format of the pixel data to generate partially converted pixel data using the processing element; and
transferring the partially converted pixel data to another processing element for further color format conversion processing.

27. The method of claim 26 wherein transferring the partially converted pixel data to the another processing element comprises:
transferring the partially converted pixel data from the processing element to at least one register; and
transferring the partially converted pixel data from the at least one register to the another processing element.

28. The method of claim 27, further comprising:
providing additional pixel data to the processing element.

29. The method of claim 28, further comprising:
partially converting the color format of the additional pixel data using the processing element after partially converting the color format of the pixel data.

30. An article comprising a machine-accessible medium having stored thereon instructions that, when executed by a machine, cause the machine to:
provide pixel data to a processing element;
partially convert the color format of the pixel data to generate partially converted pixel data using the processing element; and
transfer the partially converted pixel data to another processing element for further color format conversion processing.

31. The article of claim 30 wherein the instructions to transfer the partially converted pixel data to the another processing element, when executed by the machine, cause the machine to:
transfer the partially converted pixel data from the processing element to at least one register; and
transfer the partially converted pixel data from the at least one register to the another processing element.

32. The article of claim 31 wherein the instructions, when executed by the machine, further cause the machine to:
provide additional pixel data to the processing element.

33. The article of claim 32 wherein the instructions, when executed by the machine, further cause the machine to:
partially convert the color format of the additional pixel data using the processing element after partially converting the color format of the pixel data.
